(19) United States
(12) Patent Application Publication
(10) Pub. No.: US 2024/0407347 A1
(43) Pub. Date: Dec. 12, 2024

(54) MODULAR FISHING LURE

(71) Applicant: Ronan, Winter Garden, FL (US)

(72) Inventor: Ronan, Winter Garden, FL (US)

(21) Appl. No.: 18/736,382

(22) Filed: Jun. 6, 2024

Related U.S. Application Data
(60) Provisional application No. 63/471,514, filed on Jun. 7, 2023.

(51) Int. Cl. A01K 85/18; A01K 85/00

(52) U.S. Cl. CPC A01K 85/18; A01K 85/029; A01K 85/1803

(57) ABSTRACT

A modular fishing lure includes a body, a lip removably received by the body, a line tie extending from the body, and a lip release on the main body. The lip release is actuatable to release the lip for removal from the main body. The modular lure allows a user to quickly and easily interchange lips for any desired diving action of the modular lure.

### CROSS-REFERENCE TO RELATED APPLICATIONS

This application claims priority from U.S. Provisional Patent Application No. 63/471,514 filed on Jun. 7, 2023.

### BACKGROUND

Certain fishing lures, such as crankbait style lures, are designed to resemble baitfish. Anglers attach such fishing lures to the ends of fishing lines to attract the attention of and catch predatory species of fish.

Such fishing lures may also include a lip extending from the front of the imitation baitfish. As the fishing lure is moved through the water via movement of a fishing line, water applies a force on the lip and causes the lure to dive under the water.

Lips of such fishing lures may have various configurations which accomplish different diving depths and patterns. In particular, the size, shape, and angle of a lip can determine several different movement characteristics of the lure, such as diving depth, speed to depth, side-to-side movement or “swimming” speed, swimming pattern, etc. Typically, when an angler wants to change a diving depth or pattern while they are fishing they need to fully remove a lure in use from their line and then retie a new lure which includes a lip that is tailored to the desired diving depth or action.

### SUMMARY

In one exemplary embodiment, a fishing lure includes a body, a lip removably received by the body, and a line tie extending from the body or lip. The body includes a lip release and the lip release is actuatable to release the lip for removal from the body.

In another embodiment according to any of the previously described embodiments, the lip includes an internal portion received within a slot of the body, and an external portion that extends outward from the body.

In another embodiment according to any of the previously described embodiments, the slot is angled with respect to a longitudinal axis of the body.

In another embodiment according to any of the previously described embodiments, the external portion includes a top surface that is angled with respect to a top surface of the internal portion.

In another embodiment according to any of the previously described embodiments, the internal portion engages with the lip release.

In another embodiment according to any of the previously described embodiments, the lip release includes a protrusion engaging with a slot of the internal portion.

In another embodiment according to any of the previously described embodiments, the lip release is configured to be depressed relative to the body such that the protrusion of the lip release moves relative to the slot of the internal portion.

In another embodiment according to any of the previously described embodiments, the internal portion includes a top surface, and wherein the protrusion extends generally perpendicular to the top surface.

In another embodiment according to any of the previously described embodiments, the slot is L-shaped and includes a longitudinal portion and a lateral portion extending laterally from the longitudinal portion, and wherein the protrusion is biased by a spring into the lateral portion.

In another embodiment according to any of the previously described embodiments, at least one of the protrusion and the slot include an angled surface configured to facilitate insertion of the lip into the body.

In another embodiment according to any of the previously described embodiments, the body includes a wedge piece, and wherein the lip is secured between the wedge piece and the remainder of the body.

In another embodiment according to any of the previously described embodiments, the lip includes a non-uniform weight distribution.

In another exemplary embodiment a fishing lure includes a body, a line tic extending from the body, a first eye disposed on a first side of the body and a second eye disposed on a second, opposed side of the body, and a spring extending between the first eye and the second eye. The first eye is configured to be selectively depressed relative to the body to release a lip removably received by the body.

In another embodiment according to any of the previously described embodiments, the first eye includes a protrusion configured to engage with a slot of the lip.

In another embodiment according to any of the previously described embodiments, depressing the first eye relative to the body moves the protrusion relative to the slot of the lip.

In another embodiment according to any of the previously described embodiments, the first eye includes a button portion extending from a guide portion, the guide portion including a greater diameter than the button portion, and the protrusion extends from the guide portion.

In another embodiment according to any of the previously described embodiments, the body includes a guide channel configured to receive the guide portion of the first eye, and the guide portion and the guide channel both include a truncated cylindrical shape with a flat bottom surface.

In another embodiment according to any of the previously described embodiments further includes an outer guide tube, a lock tube and an inner guide tube attached to the first eye and movable with the first eye, wherein the spring extends within the outer guide tube and around and outside of the inner guide tube, and wherein the lock tube includes the protrusion.

An exemplary method includes activating a lip release on a body of a fishing lure to release a first lip received in the body, removing the first lip from the body, and inserting a second lip into the body.

In another exemplary method according to any of the previously described methods, the first lip includes a different weight distribution than the second lip.

### BRIEF DESCRIPTION OF THE DRAWINGS

FIG. 1 illustrates a prospective view of a modular fishing lure.

FIG. 2 illustrates the modular fishing lure with a first lip.

FIG. 3 illustrates the modular fishing lure with a second lip.

FIG. 4 illustrates an exploded view of the modular fishing lure.

FIG. 5 illustrates a locking mechanism of the modular fishing lure in a locked position.

FIG. 6 illustrates the locking mechanism in an unlocked position.

FIG. 7 schematically illustrates a second embodiment modular fishing lure in a locked position.

FIG. 8 schematically illustrates the second embodiment modular fishing lure in an unlocked position.

FIG. 9 schematically illustrates a third embodiment modular fishing lure.

### DETAILED DESCRIPTION

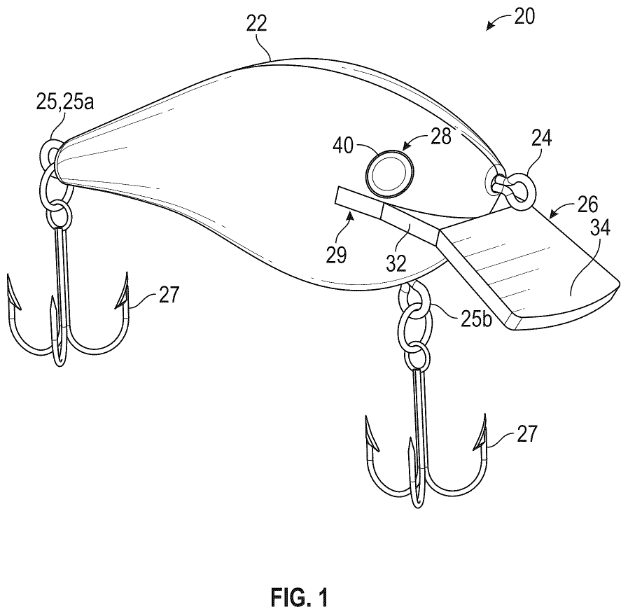

FIG. 1 illustrate a modular fishing lure 20 according to the present invention. The lure 20 generally includes a body 22, one or more line ties 24, one or more hook loops 25, an interchangeable lip 26, and a lip release 28.

The body 22 is generally configured in the shape of a baitfish, such as a minnow, shiner, shad, crawfish, etc. The body 22 may be configured similar to any “hard bait” or lip styled bait, including but not limited to crankbaits, jerkbaits, segmented swimbaits, etc. In an example, the body 22 may be plastic and may be configured such that the lure 20 floats on water when it is not moving. In other examples, the body 22 is configured such that the lure 20 sinks or suspends at depth when not moving.

One or more line ties 24 extend from the body 22, and are loops or attachment locations that allows a user to tie a fishing line to the lure 20. In the illustrated example, a line tic 24 extends from the front of the body 22 and is spaced from and not connected to the lip 26. However, in other examples, a line tie 24 may also extend from the interchangeable lip 26.

One or more hook loops 25 also extend from the body, and are loops or attachment locations that allow fishing hooks 27 to be attached to the lure 20. In the illustrated example, a first hook loop 25a is included at the tail of the body 22 and a second hook loop 25b is included at the bottom of the body 22 at a location near to the widest part of the body 22. In some examples there may be more or less than two hooks 27 attached to the lure body 22. In some examples, the hook loop 25a may alternatively be used as a line tie 24 to secure a fishing line to the lure 20.

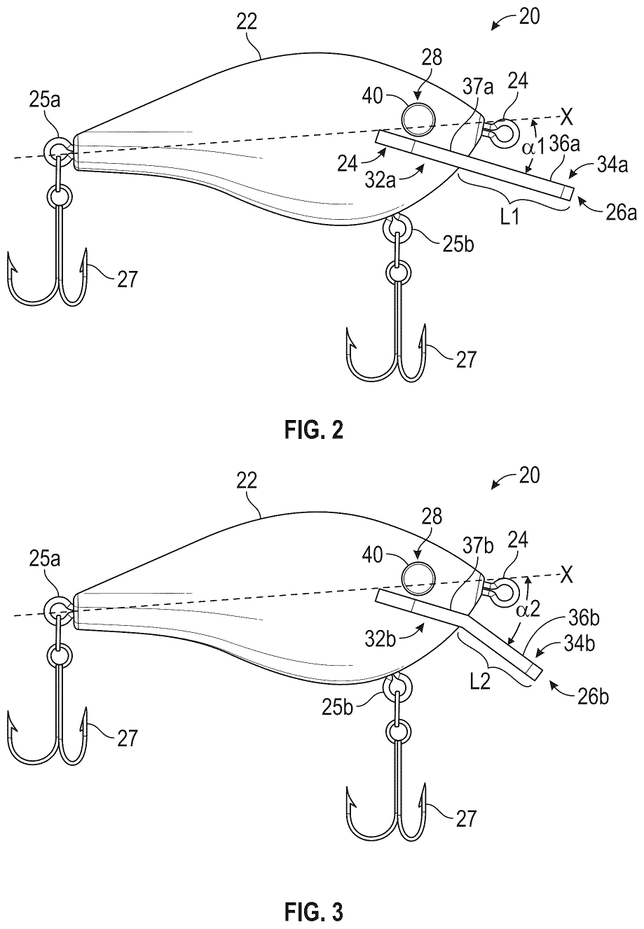

The body 22 further includes at least one slot 29 for removably receiving an interchangeable lip 26. In the illustrated example, the slot 29 is a rectangular recess extending the width of the body 22 and extending inward from the front of the body. In examples, the slot 29 may be angled downward relative to a longitudinal axis X of the body 22 defined between rearmost and forwardmost points of the body 22 (shown in FIGS. 2 and 3).

Lips 26 of the modular fishing lure 20 are interchangeable such that a user may easily exchange a lip 26 that is in use and attached to the body 22 with a different desired lip 26. In examples, the lips 26 include an internal portion 32 that is configured to be inserted into the slot 29 of the body 22 and an external portion 34 configured to extend from the front of the body 22, i.e., from the head, of the imitation baitfish. In an example, the lips 26 are formed of transparent plastic, however any appropriate material may be used.

The lips 26 enable the lure 20 to dive underwater as the lure 20 is moved through water by a fishing line attached to the line tie 24. As the lure 20 moves relative to the water, water applies a force on the external portion 34 of the lip 26. The external portion 34 of the lips 26 generally include at least one top surface 36 with a downward facing angle such that water applies a downward force on the lure 20 and causes it to dive deeper into the water as the lure 20 moves. The angle, shape, length and other design features of a lip 26 can tailor the depth and action that the lure 20 will dive to and the speed at which the lure 20 will dive to its maximum depth. Lips 26 may also include lateral elements and additional elements that can tailor side-to-side movement or wobble of the lure 20 as it moves through water.

FIG. 2 illustrates an example wherein the lure 20 has a first lip 26a with an external portion 34a that generally extends in a forward direction from the front of the body 22 and includes a flat, slanted top surface 36a. The external portion 34a of the first lip 26a extends a length L1, and the top surface 36a is arranged at an angle α1 relative to the longitudinal axis X of the body 22. In this example, the top surface 36a of the external portion 34a of the lip 26a is continuous with, and not angled relative to, a top surface 37a of the internal portion 32a. As the lure 20 is moved through water, the first lip 26a may allow the lure 20 dive to a maximum depth in the range of about eight to ten feet.

FIG. 3 illustrates an example wherein a second lip 26b has replaced the first lip 26a on the body 22. The second lip 26b includes a length L2 that is shorter than the length L1 of the first lip 26a. The second lip 26b further includes an external portion 34a with a top surface 36b that generally slants forward and down from the front of the body 22 and defines an angle α2 relative to the longitudinal axis X of the body 22. The angle α2 of the second lip 26b is much greater than the angle α1 of the first lip 26a, and in one example may be about 45 degrees. Further, the top surface 36b external portion 34b of this lip 26b is angled with respect to the top surface 37b of the internal portion 32b of the lip 26b. The second lip 26b may allow the lure 20 to dive a maximum depth in the range from about zero to one foot.

Accordingly, the second lip 26b will facilitate a diving pattern that is much shallower than the first lip 26a. The shallower diving pattern of the second lip 26b is caused by the second lip 26b having a shorter length L2 and steeper angle α2 relative to the first lip 26a, as there is less surface area for the water to apply a downward force on as the lure 20 moves.

The maximum depths described above may vary depending on several characteristics of the body 22, such as buoyancy (i.e., floating, suspending or sinking), weight, size, etc. Further, it should be understood that lips 26 of any angle, shape, length, etc., may be used with the lure 20 of this invention, including lips designed to accomplish any desired diving depth or pattern. The lure 20 may also beneficially be used without any lip 26 attached.

Further, the interchangeable lips 26 of this invention may include any weight or include a non-uniform weight distribution wherein certain portions of the lip 26 are tailored to weigh relatively more than other portions. Traditionally, certain deep diving lures have utilized line ties connected to a lip, rather than from a body of a fishing lure to obtain a desired diving action. Applicant has discovered that such desired diving actions can also be achieved with a line tie 24 located on the body 22 by tailoring the weight of an interchangeable lip 26. In an example, a lip 26 may include an external portion 34 with a greater weight than its internal portion 32. In another example, a lip 26 may include an external portion 34 with a non-uniform weight distribution, such as a weighted front portion which is heaver than a rearward portion closer to the body 22 when in use.

The lip release 28 allows a user to easily remove a lip 26 that is in use and attached to the body 22 and then easily insert a different lip 26. The lip release 28 may be a button or other articulatable feature which disengages a locking mechanism 38 that locks a lip 26 in place relative to the body. The locking mechanism 38 engages with the internal portion 32 of a lip 26 to secure the lip 26 relative to the body 22. In examples, the lip release 28 is a button shaped and positioned as one or both of the eyes 40 of the imitation baitfish.

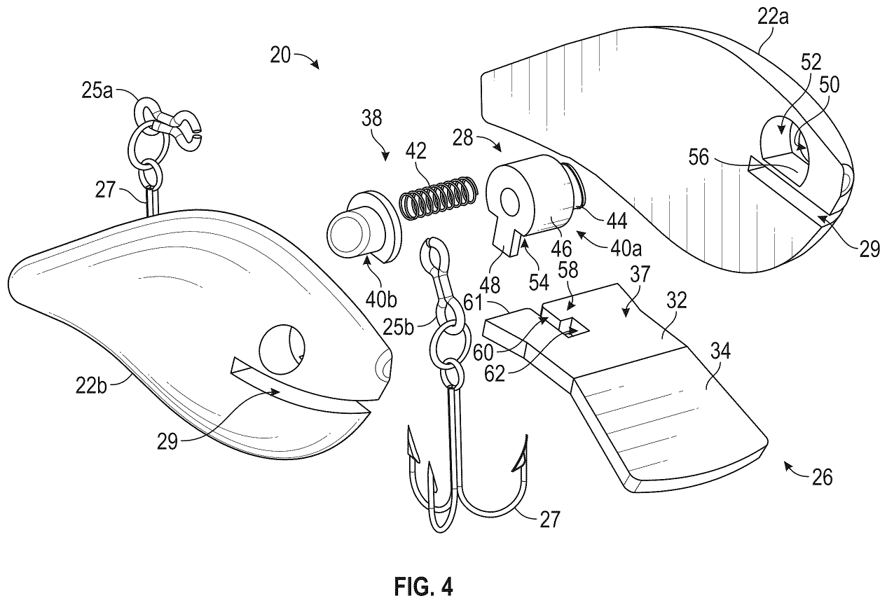

FIG. 4 illustrates an exploded view of the lure 20 including a first example lip release 28 and locking mechanism 38, and with the body 22 shown split down a central plane. In this example, the lip release 28 comprises a first eye 40a of the imitation baitfish, which may be depressed relative to the body 22 to release a lip 26 received by the body 22. The locking mechanism 38 in this example includes the first eye 40a disposed on a first side 22a of the body 22, a second eye 40b disposed on a second, opposed side 22b of the body 22, and a spring 42 extending between the first eye 40a and the second eye 40b.

The second eye 40b is configured to be rigidly received by the body 22, such that the second eye 40b is not movable relative to the body. In this example, the first eye 40a includes a button portion 44, a guide portion 46, and a protrusion 48. The body 22 includes a hole 50 configured to receive the button portion 44 and a guide channel 52 interior to the hole 50 and configured to receive the guide portion 46 of the first eye 40a. The guide portion 46 in this example may include a truncated cylindrical shape with a flat bottom surface 54. The guide portion 46 includes a greater diameter than the button portion 44. The guide channel 52 in this example likewise comprises a truncated cylindrical recess with a flat bottom surface 56. The flat bottom surface 54 of the guide portion 44 of the first eye 40a slidably engages with the flat bottom surface 56 of the guide channel. The truncated cylindrical shapes of the guide portion 44 and guide channel 52 prevent rotation of the first eye 40a as it translates.

The protrusion 48 extends from the flat bottom surface 54 of the guide portion 44. The protrusion 48 is configured to engage with a slot 58 on the internal portion 32 of each interchangeable lip 26. In the illustrate example, the slot 58 is L-shaped, including a longitudinal portion 60 extending from an inner edge 61 of the internal portion 32, and a lateral portion 62 extending laterally from the end of the longitudinal portion 60. In an example, the protrusion 48 extends in a direction which is generally perpendicular to the flat top surface 37 of the internal portion 32 of the lip 26.

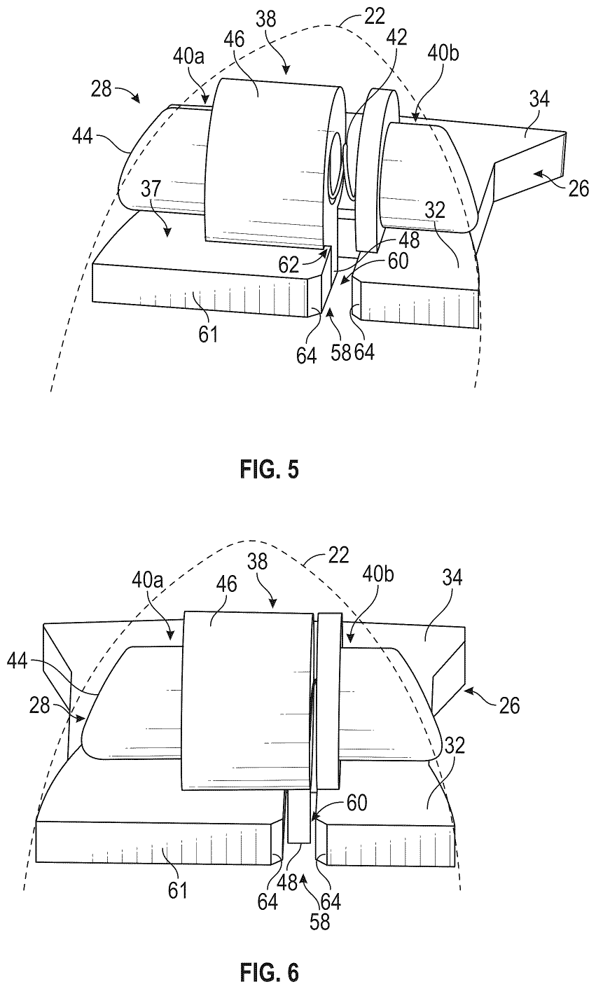

FIG. 5 illustrates the locking mechanism 38 and a lip 26 in a locked position with an outline of the body 22 shown in phantom line for illustrative purposes. In this position, the first eye 40a is biased away from the second eye 40b by the spring 42 such that the button portion 44 is biased laterally outward through the hole 50 and the guide portion 46 is biased fully into the guide channel 52. Further, the protrusion 48 is biased into the lateral portion 62 of the slot 58 of the lip 26. This engagement of the protrusion 48 and the slot 58 locks the lip 26 in place relative to the body 22 and prevents the internal portion 32 of the lip 26 from sliding out of the slot 29 of the body 22.

FIG. 6 illustrates the locking mechanism 38 and a lip 26 in an unlocked position with an outline of the body 22 shown in phantom line for illustrative purposes. In this position, a user has depressed the lip release 28, i.e., the first eye 40a, into the hole 50 to compress the spring 42 and move the first eye 40a towards the second eye 40b. As the first eye 40a translates to this position, the button portion 44 and guide portion 46 of the first eye 40a slide within the hole 50 and guide channel 52, respectively. This translation, in turn, slides the protrusion 48 out from the lateral portion 62 of the slot 58 of the lip and into a position where the protrusion is aligned with the longitudinal portion 60. From this unlocked position, the internal portion 32 of the lip 26 can be slid out from the slot 29 of the body.

Accordingly, a user can depress the lip release 28 to remove a lip 26 that is in use, and then, with the lip release 28 still depressed, insert a different desired lip 26 into the body 22. A user squeezing both eyes 40a, 40b of the imitation baitfish body 22 will cause the lip release 28 to activate. The slot 58 may include one or more angled surfaces 64 to facilitate guiding the protrusion 48 into the slot 58. The user then simply releases the lip release 28 and the locking mechanism 38 returns to a locked position wherein the new lip 26 is secured relative to the body 22.

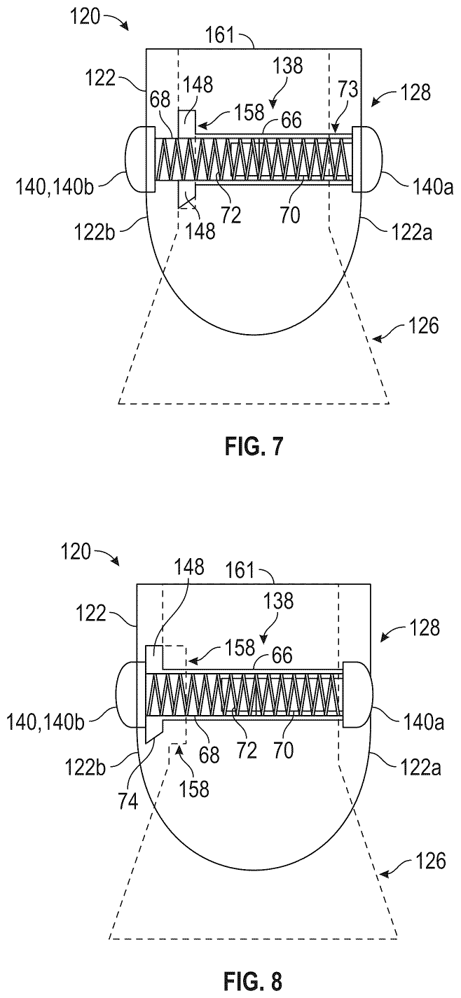

FIGS. 7 and 8 schematically illustrate another embodiment modular fishing lure 120 with another example locking mechanism 138. In this disclosure, like reference numerals designate like elements where appropriate and reference numerals with the addition of one-hundred designate modified elements that are understood to incorporate the same features and benefits of the corresponding elements.

As in the example of FIGS. 4-6, the fishing lure 120 includes a lip release 128 comprising an eye 140 of the imitation baitfish of the body 122. However, it should be understood that these examples are non-limiting, and that any known actuatable feature may be used as a lip release 28, 128 such as any appropriate type of button, latch, switch, etc.

Internally, the locking mechanism 138 in this example includes a lock tube 66, an outer guide tube 68, an inner guide tube 70, and a spring 72 disposed within a channel 73 defined in the body 122. A first eye 140a and a second eye 140b are disposed towards opposed lateral sides 122a, 122b of the body 122. The outer guide tube 68 is attached to the second eye 140b or generally attached to the second side 122b of the body 122. Both the lock tube 66 and the inner guide tube 70 are attached to the first eye 140a. The inner guide tube 70 has a smaller diameter than the outer guide tube 68 and extends at least partially within the outer guide tube 68 such that the inner guide tube 70 and outer guide tube 68 overlap a portion of the distance between the first eye 140a and the second eye 140b. The spring 72 extends between the first eye 140a and the second eye 140b. In an example, the spring 72 is a helicoid spring which extends within the outer guide tube 68 and around and outside of the inner guide tube 70. The lock tube 66 generally extends from the first eye 140a around and outside of outer guide tube 68 and includes one or more protrusions 148 at its end that is disposed towards the second side 122b of the body 122. The protrusion 148 may be a flanged end of the lock tube 66. The second eye 140b and the outer guide tube 68 are immovably affixed to the second side 122a of the body 122, whereas the first eye 140a, inner guide tube 70, and lock tube 66 may be moved or depressed relative to the first side 122a of the body 122. In this example, the interchangeable lips 126 of the lure 120 include a slot 158 on a lateral side of the internal portion 132 configured to receive the protrusion 148 of the lock tube 66.

FIG. 7 illustrates the lure 120 with the example lip release 128 and locking mechanism 138 in a locked position. In the locked position, the spring 72 biases the movable first eye 140a towards the first side 122a of the body 122. As the lock tube 66 is connected to the first eye 140a, the protrusion 148 is also biased towards the first side 122a where it abuts and is housed within slot 158 of the lip 126. The engagement of the protrusion 148 and the slot 158 hold the lip 126 immovably in place during use.

FIG. 8 illustrates the lure 120 with the example lip release 128 and locking mechanism 138 in an unlocked position. The first eye 140a is depressed by a user which overcomes the biasing force of the spring 72. The inner guide tube 70 slides within the outer guide tube 68 and the lock tube 66 slides outside of the outer guide tube 68 to guide movement of the first eye 140a components. As the first eye 140a moves towards the second side 122b, the protrusion 148 moves outside of and disengages with the slot 158 of the lip 126. With the protrusion 148 and slot 158 disengaged, the lip 126 may be withdrawn from the lure 120 by a user.

In an example, the protrusion 148 of the lock tube 66 may include an angled receiving surface 74. The angled receiving surface 74 allows a user to insert a new lip 126 without squeezing the eyes 140 because as a lip 126 is being inserted an inner edge 161 of the lip 126 abuts the angled receiving surface 74 and biases the protrusion 148 towards the unlocked position of FIG. 7.

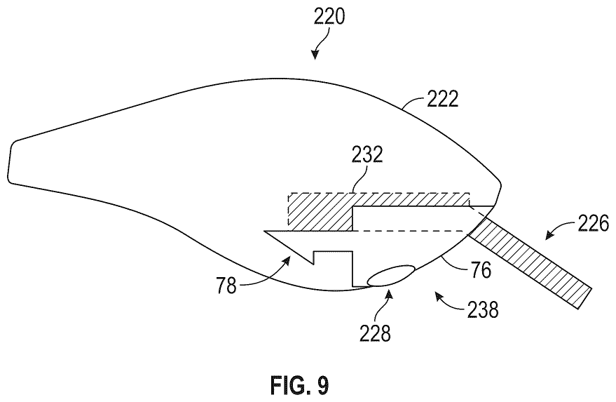

FIG. 9 schematically illustrates another embodiment fishing lure 220 with another example locking mechanism 238. In this example, a lip 226 is secured within the body 222 by a movable wedge piece 76. The wedge piece 76 may define a portion of the body 222 below the slot (not shown) in the body 222 configured to receive the internal portion 232 of the lip 226, and may define part of the outer surface of the body 222. The wedge piece 76 is moveable relative to the remainder of the body 222 between a locked position and an unlocked position.

In the locked position (shown in FIG. 9), the wedge piece 76 engages with locking structures 78 of the body 222 to secure the wedge piece 76 relative to the body 222. Further, in the locked position, a lip 226 received within the body 222 is immovably wedged and secured between the wedge piece 76 and other internal structures of the body 222 (not shown).

The body 222 and wedge piece 76 are configured such that the wedge piece 76 may be slid or pivoted relative to the rest of the body 222 into the unlocked position wherein the wedge piece 76 is either partially disengaged or fully removed from the remainder of the body 222. The wedge piece 76 may further include a lip release 228 in the form of a button or other actuatable feature which disengages the locking structures 78 or biases the wedge piece 76 out of the locking structures 78. In the unlocked position, a user may remove a lip 226 that is in use and replace it with another desired lip 226. The user then returns the wedge piece 76 to the locked position to secure the new lip 226 within the body 222.

The modular lures 20, 120, 220 of the present invention allows an angler to quickly and easily interchange lips 26, 126. 226 for any desired diving action. The modular lures 20, 120, 220 are particularly beneficial when an angler wants to adjust a diving depth or pattern while fishing. The user does not need to untie a lure from a fishing line and retie a new lure with a desired lip, as is the case with current fishing lures. As the line tie 24 extends from the body 22 of the lure 20, the user can simply use the lip release 28, 128, 228 to interchange a desired lip 26, 126, 226 shape while keeping the lure 20, 120, 220 tied to a fishing line, saving time and increasing efficiency. This feature further benefits the user by only requiring various lips 26, 126, 226 and one lure body 22, 122, 222 as opposed to requiring several lures with fixed lips for each desired depth and diving pattern.

Although a combination of features is shown in the illustrated examples, not all of them need to be combined to realize the benefits of this disclosure. In other words, a system designed according to an embodiment of this disclosure will not necessarily include all of the features shown in any one of the Figures or all of the portions schematically shown in the figures. Moreover, selected features of one example embodiment may be combined with select features of other example embodiments.

The proceeding description is exemplary rather than limiting in nature. For example, it should be understood that although specific examples of lip releases 28, 128, 228 and locking mechanisms 38, 138, 238 have been shown and described, these examples are non-limiting and other means of releasing and interchanging lips 26, 126, 226 fall within the scope of this invention. Variations and modifications to the disclosed examples may become apparent to those skilled in the art that do not necessarily depart from this disclosure. The scope of legal protection given to this disclosure can only be determined by studying the following claims.

What is claimed is:

1. A fishing lure comprising:
a body;
a lip removably received by the body;
a line tie extending from the body or lip; and
wherein the body includes a lip release, the lip release actuatable to release the lip for removal from the body.

2. The fishing lure of claim 1, wherein the lip includes an internal portion received within a slot of the body, and an external portion that extends outward from the body.

3. The fishing lure of claim 2, wherein the slot is angled with respect to a longitudinal axis of the body.

4. The fishing lure of claim 2, wherein the external portion includes a top surface that is angled with respect to a top surface of the internal portion.

5. The fishing lure of claim 2, wherein the internal portion engages with the lip release.

6. The fishing lure of claim 5, wherein the lip release includes a protrusion engaging with a slot of the internal portion.

7. The fishing lure of claim 6, wherein the lip release is configured to be depressed relative to the body such that the protrusion of the lip release moves relative to the slot of the internal portion.

8. The fishing lure of claim 6, wherein the internal portion includes a top surface, and wherein the protrusion extends generally perpendicular to the top surface.

9. The fishing lure of claim 6, wherein the slot is L-shaped and includes a longitudinal portion and a lateral portion extending laterally from the longitudinal portion, and wherein the protrusion is biased by a spring into the lateral portion.

10. The fishing lure of claim 6, wherein at least one of the protrusion and the slot include an angled surface configured to facilitate insertion of the lip into the body.

11. The fishing lure of claim 1, wherein the body includes a wedge piece, and wherein the lip is secured between the wedge piece and the remainder of the body.

12. The fishing lure of claim 1, wherein the lip includes a non-uniform weight distribution.

13. A fishing lure comprising:
a body;
a line tie extending from the body;
a first eye disposed on a first side of the body and a second eye disposed on a second, opposed side of the body;
a spring extending between the first eye and the second eye; and
wherein the first eye is configured to be selectively depressed relative to the body to release a lip removably received by the body.

14. The fishing lure of claim 13, wherein the first eye includes a protrusion configured to engage with a slot of the lip.

15. The fishing lure of claim 14, wherein depressing the first eye relative to the body moves the protrusion relative to the slot of the lip.

16. The fishing lure of claim 14, wherein:
the first eye includes a button portion extending from a guide portion, the guide portion including a greater diameter than the button portion; and
the protrusion extends from the guide portion.

17. The fishing lure of claim 14, wherein:
the body includes a guide channel configured to receive the guide portion of the first eye; and
the guide portion and the guide channel both include a truncated cylindrical shape with a flat bottom surface.

18. The fishing lure of claim 14, further comprising:
an outer guide tube;
a lock tube and an inner guide tube attached to the first eye and movable with the first eye;
wherein the spring extends within the outer guide tube and around and outside of the inner guide tube; and
wherein the lock tube includes the protrusion.

19. A method comprising:
activating a lip release on a body of a fishing lure to release a first lip received in the body;
removing the first lip from the body; and
inserting a second lip into the body.

20. The method of claim 19, wherein the first lip includes a different weight distribution than the second lip.
